(19) United States
(12) Patent Application Publication
(10) Pub. No.: US 2025/0025895 A1
(43) Pub. Date: Jan. 23, 2025

(54) Modular Shower Head

(71) Applicant: Troy Hartmann, San Diego, CA (US)

(72) Inventor: Troy Hartmann, San Diego, CA (US)

(21) Appl. No.: 18/770,433

(22) Filed: Jul. 11, 2024

Related U.S. Application Data
(60) Provisional application No. 63/513,083, filed on Jul. 11, 2023.

(51) Int. Cl. B05B 1/18

(52) U.S. Cl. CPC B05B 1/18

(57) ABSTRACT

The present invention is directed to a modular showerhead that has two different embodiments: a wall mounted showerhead and a handheld showerhead. The present invention is designed to aid in the prevention of water borne illnesses. To achieve this goal, the modular showerhead can be easily disassembled, cleaned, and reassembled. Another feature of the present invention is that it will allow facilities to minimize inventory, save money, and lower their waste output. Current shower heads are not designed to be easily taken apart and cleaned and consequently, hotels frequently discard them instead of cleaning the individual components.

### RELATED APPLICATION

This application claims priority to U.S. Provisional patent application Ser. No. 63/513,083 for a “Modular Shower Head,” filed on Jul. 11, 2023, and currently co-pending, the entirety of which is incorporated herein by reference.

### FIELD OF THE INVENTION

The presently disclosed invention relates generally to modular shower heads. The present invention is more particularly directed to a modular shower head that is easily disassembled, cleaned, and reassembled to help with the prevention of water borne illnesses.

### BACKGROUND OF THE INVENTION

The prevention of water borne illnesses is a huge concern from a public health standpoint. The concern is compounded whenever showers are offered due to the risk posed by Legionnaires disease. This disease is caused by the legionella bacteria that particularly thrive in the environment that develops inside shower heads. Once a showerhead has legionella growing inside it, there is a real risk that the bacteria is accidentally inhaled by a person via small water droplets, or the infected water is accidentally swallowed, and the water somehow makes it into the lungs. For these reasons, mitigating the risk of contracting legionnaires disease is a global goal for many facilities, including dormitories, hotels, motels, student housing, cruise ships, gyms, barracks, hospitals, homes, and other venues where showers are used.

To prevent the growth of legionella bacteria, facilities clean their shower heads on a regular basis. As mentioned earlier, shower heads are a prime breeding ground for legionella bacteria for a couple of different reasons. The first is that the warm water that is left behind after a shower is an ideal temperature for the bacteria. The second, is that other residue left behind after a shower is a nutrition source that allows the bacteria to multiply quickly. Thus, the regular cleaning of showers is imperative for facilities to ensure the health and safety of their patrons.

More generally, there are several different external and internal factors leading to the development of bacteria within a shower head, but one of the biggest contributors for shower systems is the small amount of hot water that is left behind. The temperature of the hot water left behind is the ideal temperature for legionella bacteria (the bacteria that causes legionnaires disease), and, as mentioned above, the residue inside the showerhead is a nutrition source for the bacteria that lets it multiply at a high rate. This creates a potentially large health risk for any facility with a large plumbing system due to how quickly the bacteria can grow.

Currently available showerheads, including those used at dormitories, hotels, motels, student housing, cruise ships, gyms, barracks, hospitals, homes, and other venues where showers are used, are not designed with the ease of cleaning in mind. The exterior of showerheads can be easily cleaned, but cleaning the interior, where the bacteria thrive, is particularly difficult. The showerheads now commonly used are difficult or impossible to disassemble into their individual parts, making the necessary cleaning a difficult and time-consuming task. Frequently, instead of taking the time to clean each shower head, facilities across the country with a large plumbing system with multiple showerheads have resorted to simply removing, throwing away and replacing each showerhead on a time schedule. If the facilities do not throw away the shower head and have a preventative maintenance program for shower heads, it is a time-consuming process. The standard practice for hotel chains such as Hilton, Marriott, and Marriott Vacations is to remove the shower heads from guest rooms every 3 months. The engineers remove them, take them to the engineering office then soak them in a solution to disinfect the shower heads. This is in addition to removing the scale and unclogging the water spray holes. Then the engineering staff must return to all the guest rooms and re-install the cleaned shower heads. This is an incredibly wasteful practice that needlessly increases the trash output of these facilities, and significantly increases the cost of addressing the Legionnaire's problem.

All the issues outlined above have created a demand for a showerhead that is designed to better improve the cleaning process, minimize expense, and reduce the trash output. It would be advantageous to provide an easily cleaned showerhead to meet the needs of the hospitality industry and other facilities that provide showers.

### SUMMARY OF THE INVENTION

The present invention was designed with both ease of cleaning and time efficiency in mind. The present invention is a modular showerhead that can be quickly disassembled, cleaned, and reassembled. In a preferred embodiment each showerhead is modular and comes with a decorative cover that secures all the different components in the interior of the showerhead body. When a showerhead needs to be cleaned, all that a cleaner needs to do is unscrew the cover, remove the interior components, clean, or replace each part, and then reassemble the unit. In this embodiment, there are two different parts that were specifically designed to easily unscrew so that the rest of the components can be removed from the showerhead and cleaned. Further, each part of the entire assembly is a stand-alone piece that can be easily separated from each other.

The present invention will enable facilities and other users to save time and money in an area where they currently spend a significant amount of money to prevent a disease. Any dormitory, hotel, motel, student housing, cruise ship, gym, barracks, hospital, home, and other venues where showers are used will see the immediate benefit of the present invention which results from the modularity of the invention. The ease of disassembly, cleaning, and reassembling will allow hotels and others to seamlessly update their cleaning protocols to include the cleaning of the modular showerhead without noticing a significant increase in time. Further, since the present invention can be easily cleaned, it will no longer be necessary to swap out entire showerheads; instead of throwing out the entire showerhead, shower owners will only need to keep replacement parts in stock to replace parts that break or wear out during the ordinary course of use.

An embodiment of the present invention that is particularly useful for commercial applications can be used in most hotels due to the different embodiments and design considerations. The embodiment provides a showerhead that can be wall mounted and can simply replace existing showerheads already installed.

Another embodiment is a handheld showerhead that can be used in Americans with Disabilities Act (ADA) compliant showers, sitting showers, or in any other shower that a facility, or other commercial or residential user, may want it installed in. Providing even more flexibility in design, each embodiment of the present invention can be designed to meet a specific flow rate, or pressure as required by municipal code, state code, or hotel policy.

The shower heads of the present invention can be opened while still attached in showers, they can be cleaned with a simple cleaning solution, then wipe off the stainless-steel spray plate with a 50% Distilled water and 50% white vinegar solution. The shower head looks brand new, has removed any calcification to restore optimum water spray flow rates, and is free from legionella. This simple cleaning process can be done by anyone at the property without the need to have engineering staff remove, clean, then re-install the shower heads. In addition, to the cleaning benefit, the stainless-steel spray plate, the rubber gasket, or the locking ring can all be replaced without throwing the shower head away. Having to throw away a piece of the shower head is less waste thrown into local landfills thus creating another benefit to the environment.

The wall mounted shower heads of the present invention have been certified by Water Sense EPA Criteria for 1.75 gpm, 1.50 gpm, 1.25 gpm, and the handheld version has been certified for 1.50 gpm, and 1.25 gpm.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a bottom perspective view of the wall mounted showerhead assembly fully assembled and ready for use;

FIG. 2 is a top perspective view of the wall mounted showerhead assembly detailing the attachment to an existing shower pipe;

FIG. 3 is a side view of the wall mounted showerhead assembly;

FIG. 4 is a bottom view of the wall mounted showerhead assembly;

FIG. 5 is a top view of wall mounted showerhead assembly;

FIG. 6 is an exploded view of the wall mounted showerhead assembly showing the body formed to receive a spray panel formed with water holes and secured in place against the body with a decorative cover that is removable to provide access to the internal components and surfaces for cleaning and repair;

FIG. 7 is a perspective view of the handheld showerhead assembly showing the body formed with a handle and attachable to most shower hoses;

FIG. 8 is a side view of the handheld showerhead assembly;

FIG. 9 is a front view of the handheld showerhead assembly;

FIG. 10 is an exploded view of the handheld showerhead assembly showing the body formed to receive a spray panel formed with water holes and secured in place against the body with a decorative cover that is removable to provide access to the internal components and surfaces for cleaning and repair; and

FIG. 11 is a collection of bottom views of the wall mounted showerhead assemblies each formed with a distinct removal feature to facilitate the removal of the decorative covers from the showerhead body for inspection and cleaning.

### DETAILED DESCRIPTION

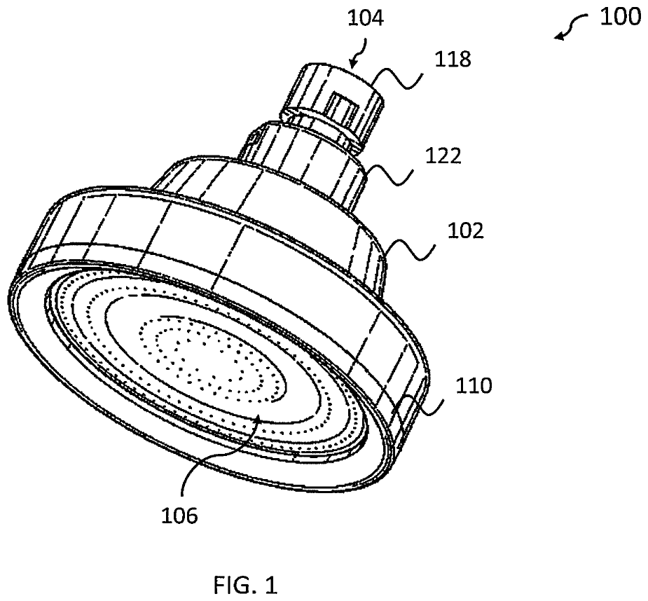

Referring initially to FIG. 1, a bottom perspective view of wall mounted assembly 100 is shown. This figure shows the entire wall mounted assembly 100 fully assembled and ready for use in any given shower. A hollow shower head body 102 is one of the main components of assembly 100 and has several notable design considerations. The first consideration is that it is designed to house the interior components of assembly 100, and it is also designed to form watertight seals at two different locations, ensuring that water enters at inlet end 104 and exits only through nozzle end 106. The second consideration is that body 102 was designed so that the entire assembly can be quickly disassembled, cleaned, repaired if needed, and reassembled.

Another component that was designed to accommodate this ease-of-cleaning consideration is decorative cover 110. Decorative cover 110 was specifically designed to allow for it to be easily unscrewed from body 102 and be reinstalled once the cleaning process for the entire assembly is complete. This consideration is one example of the features that sets the present invention apart from currently available showerheads.

Another feature of this assembly is ball joint 118. Ball joint 118 is what allows wall mounted assembly 100 to attach to a shower arm that is protruding from a wall. Nut 122 encases the ball portion of ball joint 118 and allows a user to move wall mounted assembly 100 to a preferred showerhead position. Ball joint 118 is secured to body 102 by nut 122 which is sized to encapsulate the ball portion of the joint and threadably connected to body 102.

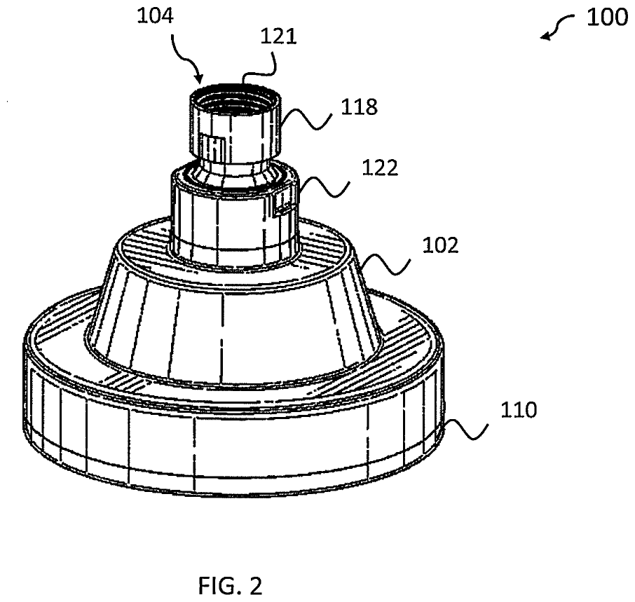

Referring now to FIG. 2, a top perspective view of wall mounted assembly 100 is shown. From this view, ball joint threading 121 is shown and, in preferred embodiments, is configured to match the universal standard for pipe threading. This allows wall mounted assembly 100 to be easily installed in most, if not all scenarios. This view also better illustrates how nut 122 secures ball joint 118 to wall mounted showerhead body 102. As mentioned earlier, nut 122 is sized to encapsulate the ball portion of ball joint 118 so that ball joint 118 is secured against body 102, but it still allows the entire assembly to be maneuvered to a preferred shower position.

Another important feature of nut 122 is that it can be easily unscrewed from body 102 to aid in disassembly of the entire unit. After the cleaning of the assembly is complete, wall mounted assembly 100 and ball joint 118 are pushed together again so that nut 122 can be easily screwed back on to body 102; in this way, the entire wall mounted assembly 100 can be reinstalled for use. Much like decorative cover 110, this design consideration for nut 122 is one exemplary distinction that sets the present invention apart from showerheads currently available in the market.

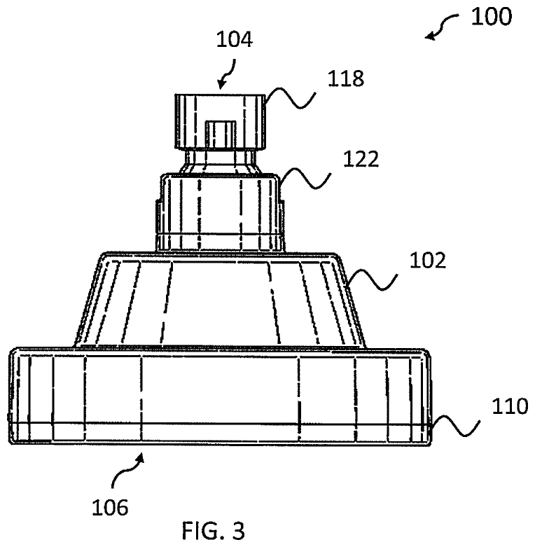

Referring now to FIG. 3, a side view of fully assembled wall mounted assembly 100 is shown. Decorative cover 110 is fully screwed on so that it is flush with body 102. This union is also a watertight seal that body 102 was designed to have to ensure that water does not leak out of the sides of assembly 100 when assembly 100 is in use. The second union also provides a watertight seal when nut 122 is also fully screwed into and flush with body 102. Thus, water entering at inlet end 104 is directed through body 102 to exit at nozzle end 106 without escaping at other parts of assembly 100.

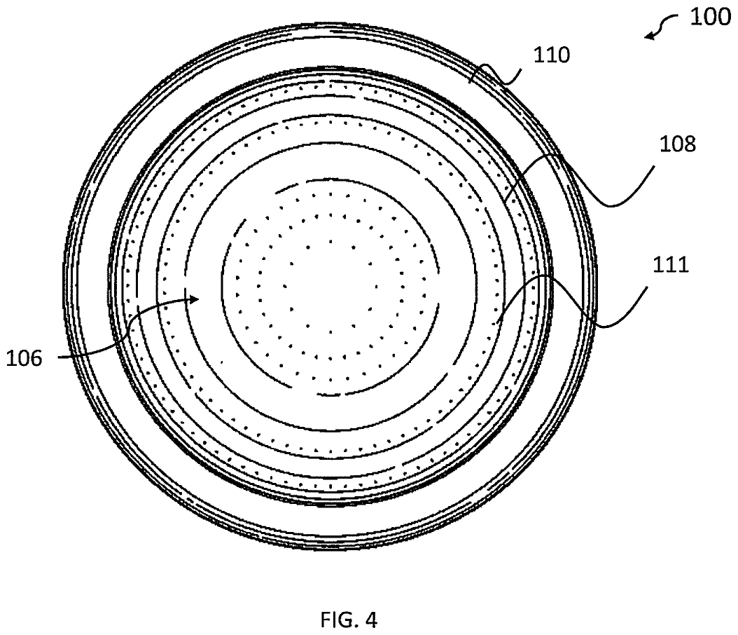

Referring now to FIG. 4, a bottom view of wall mounted assembly 100 is shown, illustrating the details of nozzle end 106. In a preferred embodiment, spray panel 108, secured in place by decorative cover 110, is shown with a particular configuration for multiples of water holes 111 in this embodiment. This pattern allows for a specific water spray pattern to occur; however, there are other embodiments for a spray panel fully envisioned that include different configurations for water holes 111. These different configurations can create a variety of spray patterns, and be designed to meet specific flow rate requirements, pressure requirements, or both. This flexibility of design will allow wall mounted assembly 100 to be designed to fit a wide variety of different scenarios. Additionally, spray panel 108 can be replaced after installation to accommodate ever-changing demands of municipalities or environmental conditions without replacing the entire device.

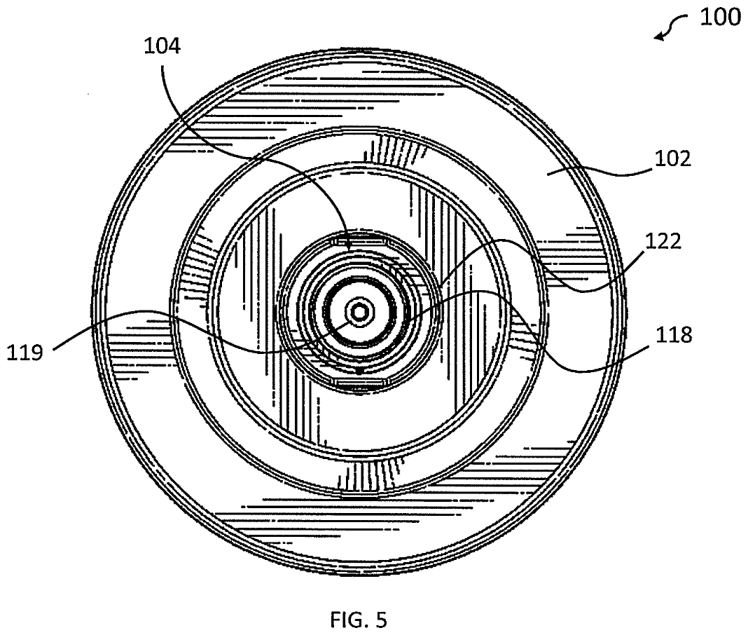

Referring now to FIG. 5, a top view of wall mounted assembly 100 is shown. This view shows the interior of ball joint 118 with aperture 119 on inlet end 104 for water to pass through into the rest of the assembly 100. As mentioned earlier, ball joint 118 is what will allow the entire assembly 100 to be repositioned, but it does not move so much that aperture 119 is blocked and water flow halted.

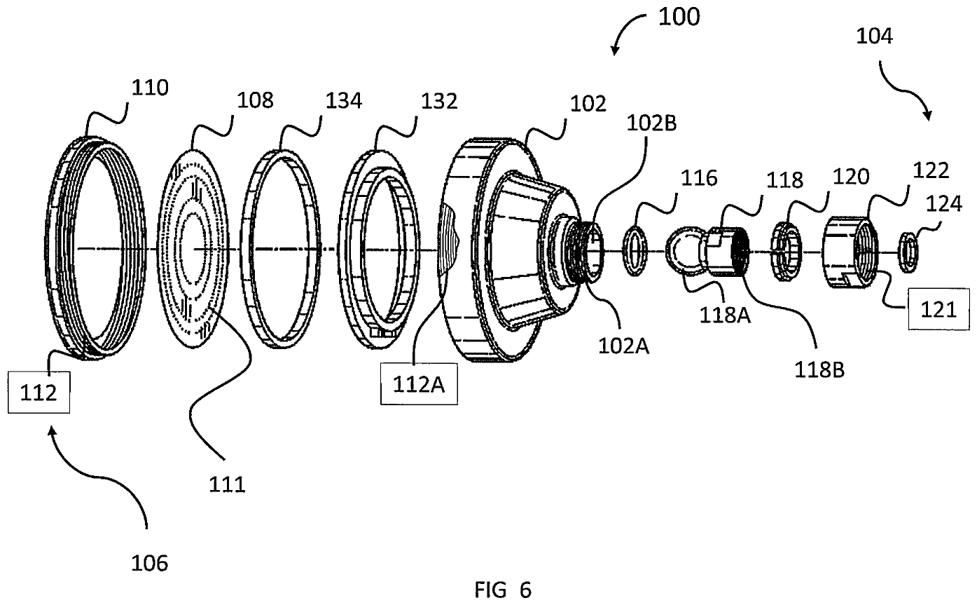

Referring now to FIG. 6, an exploded view of wall mounted assembly 100 is shown. Shown in the middle of the figure is body 102 formed with a water channel, or aperture, 102B through which water passes through body 102 from inlet end 104 to nozzle end 106. The interior components of the assembly that will be part of the cleaning process are shown to the left of body 102. The individual pieces that allow wall mounted assembly 100 to be connected to an arm are shown to the right of the body 102.

Starting with the interior components within body 102, water dispensing tablet 132 is the first piece positioned to rest inside body 102, is formed with an aperture that allows water to flow through the tablet 132 from inlet end 104 through body 102 to nozzle end 106. It forms a seal with the internal surface of body 102 and is responsible for directing the flow of water through the entire assembly, and, more particularly, it directs the flow so that it exits the assembly through spray panel 108. The second interior component is seal 134 which rests in between water dispensing tablet 132, and spray panel 108. Seal 134 forms a watertight seal between water dispensing tablet 132 and spray panel 108 once it is fully compressed due to the securing of decorative cover 110 to body 102. The third interior component is spray panel 108 formed with perforations, or water holes 111, which is where the water will flow out of when in use. Some preferred embodiments of spray panel 108 are designed to meet a specific flow rate requirement, pressure requirement, or both. Decorative cover 110 is what will secure all the interior components in place. This is achieved through threading 112 that matches corresponding threading 112A, located on the interior of body 102 and shown via a partial cut-away portion of body 102.

Decorative cover 110 has a couple of important functions for the entire assembly in addition to holding the interior components in place. The first function is that decorative cover is what allows the entire wall mounted assembly 100 to easily be disassembled, cleaned, repaired if necessary, and reassembled. In this embodiment, a person cleaning the shower head, such as a hotel room cleaner or maintenance team member, can simply unscrew decorative cover 110 and easily remove the interior components (decorative cover 110, spray panel 108, seal 134, and water dispensing tablet 132) so that they can be cleaned quickly and efficiently. While the internal components 132, 134, 108 and 110 are removed, the interior surfaces of body 102 can be quickly and easily cleaned and disinfected. Once the cleaning process is completed the cleaner just needs to reinstall each interior component and screw back on decorative cover 110 to secure each piece in place. The second important function of decorative cover 110 is that once it is screwed in, it will provide the compressive force to seal 134 so that a watertight seal is formed between water dispensing tablet 132 and spray panel 108.

Moving on to the components exterior to body 102, the parts that allow wall mounted shower assembly 100 to be secured to a shower arm protruding from a wall are shown. O-ring 116 is the first component and is inserted into the interior of the threaded nipple 102A, of body 102. As shown, threaded nipple 102A is circular in cross-section, or cylindrical, and externally threaded in preferred embodiments. Ball joint 118 is inserted into the threaded nipple 102A next and the ball portion 118A of the ball joint 118 is pushed into O-ring 116. Further, O-ring 116 forms a watertight seal between ball 118A and threaded nipple 102A when wall mounted assembly 100 is fully assembled and ball joint 118 is encapsulated between seal 120 and held in place by threaded nut 122, thus preventing water from leaking out of the side of assembly 100. Threading 121 is located on the interior of ball joint 118 is how wall mounted shower assembly 100 is attached to the corresponding shower arm.

Making up the rest of the exterior components of body 102 are lining 120, nut 122, and washer 124. Lining 120 wraps around ball joint 118 and when nut 122 is tightened, seals ball 118A to O-ring 116 and provides stability to the joint when the shower is fully assembled. Threaded nut 122 is attached to threaded nipple 102A of body 102 by screwing onto the threaded portion as both components will have corresponding threading to ensure a proper fit. Further, securing nut 122 is what provides the compressive force to create a watertight seal between ball joint 118 and O-ring 116. Washer 124 is positioned within the internal threaded portion 118B of ball joint 118 to establish a watertight seal between ball joint 118 and the showerhead supply pipe, and to prevent damage to ball joint 118 when the entire assembly is attached to the water pipe. This ensures the integrity of the entire wall mounted assembly 100 and increases the lifespan of the unit.

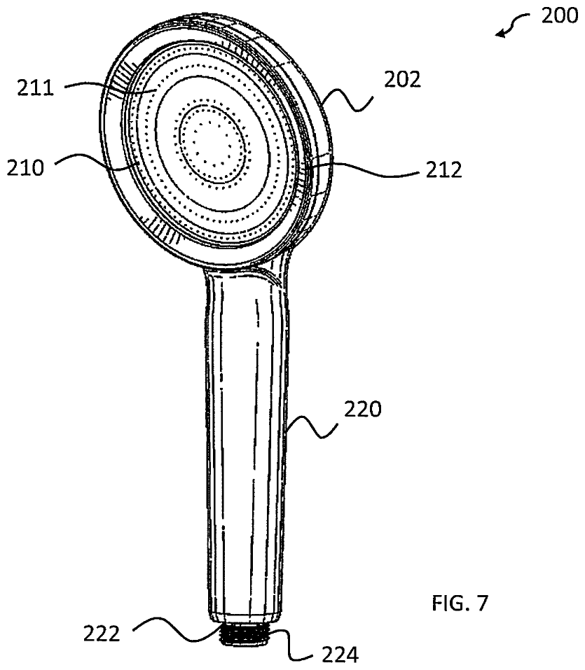

Referring now to FIG. 7, a perspective view of handheld showerhead assembly 200 is shown. Handheld showerhead assembly 200 is designed to be used in ADA compliant showers or in other showers where a bench is installed. Much like body 102 (shown in FIGS. 1-6), handheld shower body 202 is one of the main components of the entire assembly and has several important design considerations. The first consideration is that it is designed to house the interior components of the assembly, and it is also designed to form watertight seals at two different locations. The second consideration is that handheld shower body 202 was designed to allow for quick disassembly, cleaning, and reassembly. This consideration is one example of what sets the present invention apart from shower heads currently available on the market.

Handheld shower body 202 holds all the interior components, and includes handle 220, which is where a user will grip the device while using it during a shower. Shower hose attachment 222 secures to the bottom of handheld shower body 202 and threading 224 attaches to the flexible shower hose that is commonly used in ADA compliant and sit-down showers. In a preferred embodiment, threading 224 is designed so that handheld showerhead assembly 200 has universal application. Decorative cover 212 screws onto handheld showerhead assembly 202 and secures spray panel 210. As described above, spray panel 210 can be designed to accommodate any spray pattern, and any flow rate requirements, pressure requirements or both.

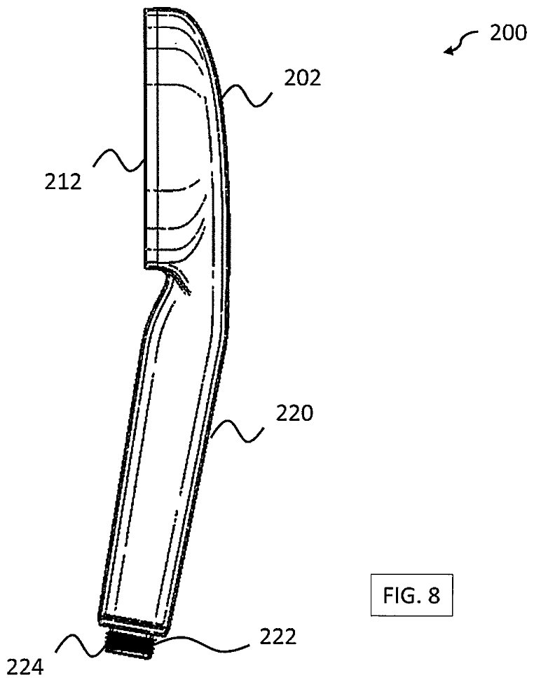

Referring now to FIG. 8, a side view of handheld showerhead assembly 200 is shown fully assembled. Decorative cover 212 is fully screwed into handheld body 202. Similarly, shower hose attachment 222 extends from the bottom of handheld body 202. It is attached at the bottom of handle 220 of handheld body 202 in a preferred embodiment, but in other exemplary embodiments it is formed with, glued, or otherwise affixed to the interior, or attached by other methods known in the art. In preferred embodiments, both decorative cover 212 and shower hose attachment 222 can be easily unscrewed and screwed back on again to ensure that the entire assembly can be easily taken apart and cleaned as needed. Threading 224 is also shown and has corresponding threading designed to match the threading of most shower hoses. Threading 224 being a universal size is useful in allowing handheld showerhead assembly to be used in a variety of different industries.

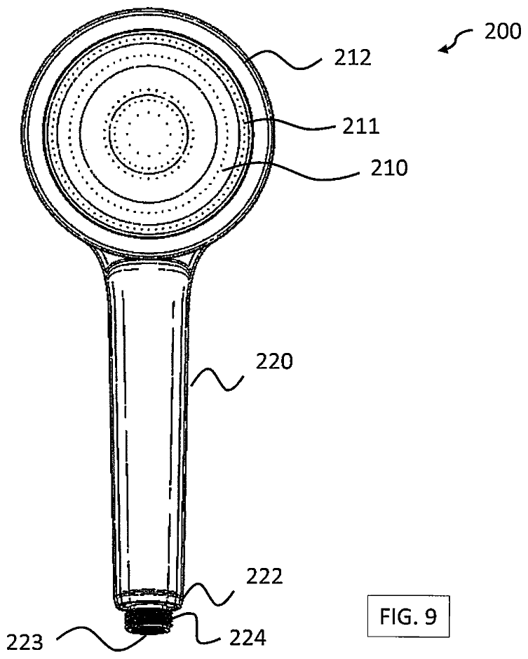

Referring now to FIG. 9, a front view of handheld showerhead assembly 200 is shown. In this view, multiples of water holes 211 are shown arranged in a specific configuration on spray panel 210. This pattern allows for a specific water flow pattern to occur; however, there are other embodiments for a spray panel 210 fully envisioned that include different configurations for water holes 211. The size, placement, and number of water holes 211 can be configured to meet any flow rate requirements, pressure requirements, or both.

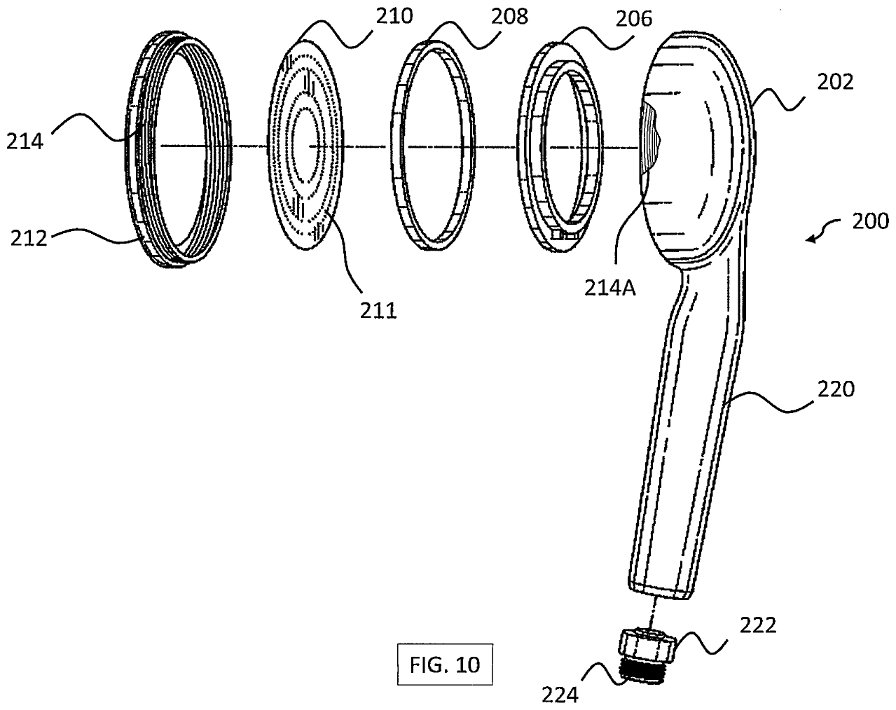

Referring now to FIG. 10, an exploded view of handheld showerhead assembly 200 is shown. Handheld body 202 is shown with water dispensing tablet 206, seal 208, spray panel 210, and decorative cover 212 shown to the left of handheld body 202. Water dispensing tablet 206 is positioned on the interior handheld body 202 and is what directs the flow of water when the shower is in use. Seal 208 is between water dispensing tablet 206 and spray panel 210 so that a watertight seal is formed when all the components are installed inside handheld body 202. Water holes 211 of spray panel 210 are where the water will flow out of the handheld assembly 200 when in use. Decorative cover 212 has threading 214 that will match corresponding threading 214A which is located on the interior of handheld body 202.

Decorative cover 212 allows the entire handheld assembly 200 to be easily disassembled, cleaned, repaired if necessary, and reassembled. Decorative cover 212 screws into handheld body 202 and is what prevents leaks by compressing seal 208 in between spray panel 210 and water dispensing tablet 206. Once decorative cover 212 is unscrewed, a person cleaning the device, such as a hotel cleaner, can easily remove each interior component such that each individual piece (decorative cover 212, spray panel 210, seal 208, and water dispensing tablet 206) can be cleaned quickly and efficiently. Once the cleaning process is completed the cleaner simply reinstalls each component and screws decorative cover 212 into body 202 to secure each piece in place.

Shower hose attachment 222 extends from the bottom of handheld body 202 and has an aperture 223 (shown in FIG. 9) to allow water to flow from the shower hose and into handheld shower assembly 200. In a preferred embodiment, shower hose attachment 222 attaches to handheld body 220 by screwing into the bottom of handheld body 202. Threading 224 on shower hose attachment 222 facilitates connection of the handheld shower head assembly 200 to a shower hose in a preferred embodiment. Further, threading 224 is sized so that it has universal threading so that handheld assembly 200 can be used in most scenarios.

Another feature of the preferred embodiments of the present invention is the universality of the different internal components. More specifically, decorative cover 110, spray panel 108, seal 134, and water dispensing tablet 132 were sized to be the same size as decorative cover 212, spray panel 210, seal 208, and water dispensing tablet 206. This design choice further improves the economic efficiency because there will be no need to have different components that are designed for either wall mounted or handheld embodiments. Any interior component that breaks can be easily replaced without needing to check which model it was designed for, thus minimizing inventory requirements for the operation and maintenance of facilities using the showerhead of the present invention.

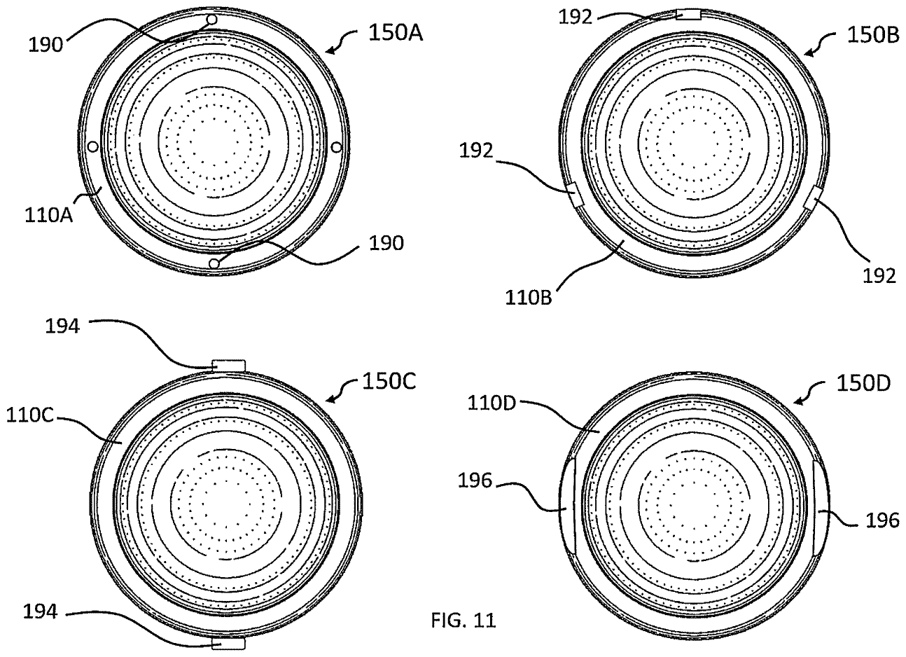

Referring now to FIG. 11, several bottom views of the wall mounted showerhead assemblies 150A-D are shown with each formed with a distinct removal feature to facilitate the removal of the decorative covers 110 from the showerhead body 102 for inspection and cleaning. Referring to showerhead assembly 150A, decorative ring 110A is formed with several cylindrical keyways 190 which are sized to receive a key having protrusions positioned to match the keyways 190 to facilitate the rotation of decorative ring 110A. With this embodiment of decorative ring 110A having four keyways 190, a four-protrusion key is used to engage the decorative ring 110A and either tighten or loosen the decorative ring 110A from body 102. The number and position of keyways 190 can vary without departing from the present invention.

Referring to showerhead assembly 150B, decorative ring 110B is formed with three peripheral slots 192 which are sized to receive a key having protrusions positioned to match the slots 192 to facilitate the rotation of decorative ring 110B. With this embodiment of decorative ring 150B having three slots 192, a three-prong key is used to engage the decorative ring 150B and either tighten or loosen the decorative ring 150B from body 102.

Referring to showerhead assembly 150C, decorative ring 110C is formed with a pair of opposing tabs 194 which are positioned on opposite sides of decorative ring 110C to provide grip points for either a manual grip enhancement to facilitate the manual removal of the decorative ring 110C from the body 102, or can be positioned to cooperate with a corresponding tool engageable with the tabs 194 to facilitate the rotation of decorative ring 110C. While this embodiment of decorative ring 110C is shown having two tabs 194, it is to be appreciated that the number of tabs 194 as well as the position of those tabs 194 around the periphery of decorative ring 110C may vary without departing from the present invention.

Referring to showerhead assembly 150D, decorative ring 110D is formed with a pair of grooves 196 positioned on opposite sides of decorative ring 110D to receive a custom sized tool or box wrench. The tool or wrench is engageable with the grooves 196 to facilitate the rotation of decorative ring 110D. While this embodiment of decorative ring 110D is shown having two grooves 196, it is to be appreciated that the number of grooves 196 as well as the position of those grooves 196 around the periphery of decorative ring 110D may vary without departing from the present invention.

The shower heads of the present invention in a preferred embodiment are made from 100% ABS Plastic, the connection for the wall mount is 100% brass, the spray plate is stainless steel, the locking ring is ABS Plastic, and the gasket is rubber silicone. It is to be appreciated that these materials are only exemplary of a preferred embodiment, and that other materials may be used without departing from the present invention.

While there have been shown what are presently considered to be preferred embodiments of the present invention, it will be apparent to those skilled in the art that various changes and modifications can be made herein without departing from the scope and spirit of the invention.

I claim:

1. A modular shower head, comprising:
a hollow shower head body formed with a water channel;
a water dispensing tablet within the hollow shower head body and formed with an aperture aligned with the water channel;
a seal placed onto the water dispensing tablet;
a spray panel adjacent the seal and formed with a plurality of spray holes; and
a cover removably attachable to the hollow shower head body that secures the water dispensing tablet, the seal, and the spray panel inside the hollow shower head body.

2. The modular shower head of claim 1, wherein the hollow shower head body is shaped to be a wall mounted shower head having a circular protrusion on the exterior.

3. The modular shower head of claim 2, further comprising an O-ring placed into the circular protrusion.

4. The modular shower head of claim 3, further comprising a ball joint placed onto the O-ring.

5. The modular shower head of claim 4, further comprising a nut that encapsulates the ball joint by attaching onto the protrusion of the hollow shower head body.

6. The modular shower head of claim 1, wherein the hollow shower head body is a handheld shower head and further comprises a handle portion.

7. The modular shower head of claim 6, wherein the shower head body is configured to attach to a shower hose at the bottom of the handle portion.

8. A wall mounted modular shower head, comprising:
a hollow body with a front, a back, and a circular protrusion extending from the back;
a water dispensing tablet positioned within the interior of the hollow body;
a seal placed onto the water dispensing tablet;
a spray panel formed with a plurality of water-dispensing holes and positioned onto the seal; and
a cover that removably attaches to the front of the hollow body to capture the spray panel between the seal and the cover.

9. The wall mounted modular shower head of claim 8, further comprising an O-ring placed onto the circular protrusion.

10. The wall mounted modular shower head of claim 9, further comprising a ball joint placed onto the O-ring.

11. The wall mounted modular shower head of claim 10, further comprising a nut that encases the ball joint and threads onto the exterior threading of the hollow body to establish a watertight seal between the circular protrusion and the O-ring, and between the O-ring and the ball joint.

12. The wall mounted modular shower head of claim 8, further comprising:
the hollow body formed with interior threading;
the cover formed with external threads corresponding to the interior threading wherein the cover can be threadably attached to the hollow body to establish a watertight seal between the water dispensing tablet and the seal, and between the seal and the spray panel.

13. A handheld modular shower head, comprising:
a hollow body having a circular top portion with interior threading, the body narrowing down into a handle portion;
a water dispensing tablet inserted into the interior of the hollow body;
a seal placed onto the water dispensing tablet;
a spray panel having multiple spray holes, the spray panel positioned onto the seal; and
a removeable cover formed with external threading and removably threaded into the interior threading of the circular top portion of the hollow body to capture the spray panel between the seal and the cover.

14. The handheld modular shower head of claim 13, wherein the hollow body is configured to attach to a shower hose at the bottom of the handle portion.
